(19) United States
(12) Patent Application Publication
(10) Pub. No.: US 2003/0229553 A1
(43) Pub. Date: Dec. 11, 2003

(54) Automated online underwriting

(76) Inventors: Phanporn Kongyingyong, Bangkok (TH); Waiyot Piyakulvorarat, Bangkok (TH); Preeyanuch Sayasaywee, Bangkok (TH); Niti Kanchanasthiti, Bangkok (TH); Salisa Hanpanich, Bangkok (TH); Kittikhun Landaeng, Nontaburi (TH); Boonlerd Sinsombat, Bangkok (TH); Terence Mak, New York, NY (US)

Correspondence Address: BUCKLEY, MASCHOFF, TALWALKAR, & ALLISON, 5 ELM STREET, NEW CANAAN, CT, 06840, US

(21) Appl. No.: 10/165,664

(22) Filed: Jun. 7, 2002

(51) Int. Cl. G06F 17/60

(52) U.S. Cl. 705/35

(57) ABSTRACT

A user interface for evaluating an underwriting decision is described. The user interface includes in some aspects a first area for presenting a financial exposure associated with an entity, the financial exposure including at least an indication of an outstanding loan balance of the entity, a second area for presenting a repayment rating associated with the entity, and a third area for presenting a credit score associated with the entity, the credit score based at least on demographic information associated with the entity, wherein the repayment rating is presented in the second area if an appropriate repayment history associated with the entity is available, and wherein the credit score is presented in the third area if the appropriate repayment history is not available.

### BACKGROUND

1. Field

The present invention relates to systems for presenting information. More specifically, some aspects of the present invention concern systems for presenting customer financial information to underwriting decision makers.

2. Discussion

Modern businesses rely on computer systems to execute their various business functions. A typical business may operate several different computer systems, with each system addressing a particular need. Some business functions, such as underwriting, often rely on disparate data generated by two or more computer systems.

According to conventional underwriting systems, an analyst receives an application for loan or credit from an entity such as a business or an individual. The analyst uses tools at her disposal to gather relevant data corresponding to the subject entity. This data often includes a credit report corresponding to the entity and information regarding the performance of loans and/or credit already extended to the customer. The analyst then determines whether to approve the application based on the collected information.

The foregoing process is often inadequate and inefficient. In one example, credit reports corresponding to new entities and to entities based in developing countries are often not available. In these cases, the analyst is left to approve or reject the application based on raw financial information corresponding to the customer. In other examples, a tool is provided to evaluate the financial information and to provide a recommendation. Analysts do not rely solely on such recommendations because the recommendations are not presented in a manner that provides a full appreciation of the merits of the application.

In view of the foregoing, what is needed is a system to present information associated with an entity that provides efficient and adequate analysis of the entity for underwriting purposes.

### BRIEF DESCRIPTION

In order to address the foregoing, embodiments of the present invention concern a system, a method, an apparatus, a computer-readable medium storing processor-executable process steps, and means to present a user interface and a user interface comprising a first area for presenting a financial exposure associated with an entity, a second area for presenting a repayment rating associated with the entity, the repayment rating based at least on a repayment history of the entity, and a third area for presenting a credit score associated with the entity.

A technical content of some embodiments of the invention is an efficient consolidation of previously disparate underwriting functions. With this and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a diagram of a system architecture according to some embodiments of the invention.

FIG. 2 is a block diagram illustrating an internal architecture of a data warehouse according to some embodiments of the present invention.

FIG. 3 is a block diagram illustrating an internal architecture of a user device according to some embodiments of the present invention.

FIG. 4 is a tabular representation of a portion of a customer database according to some embodiments of the present invention.

FIG. 5 is a tabular representation of a portion of a customer exposure database according to some embodiments of the present invention.

FIG. 6 is a tabular representation of a portion of an exposure parameter database according to some embodiments of the present invention.

FIG. 7 is a tabular representation of a portion of a repayment history database according to some embodiments of the present invention.

FIG. 8 is a tabular representation of a portion of a repayment rating database according to some embodiments of the present invention.

FIG. 9 is a tabular representation of a portion of a scorecard database according to some embodiments of the present invention.

FIG. 10 illustrates a flow diagram of process steps to present a user interface according to some embodiments of the invention.

FIG. 11 is an outward view of a user interface according to some embodiments of the present invention.

FIG. 12 is an outward view of a user interface according to some embodiments of the present invention.

FIG. 13 is an outward view of a user interface according to some embodiments of the present invention.

FIG. 14 is an outward view of a user interface according to some embodiments of the present invention.

FIG. 15 is an outward view of a user interface according to some embodiments of the present invention.

FIG. 16 is an outward view of a user interface according to some embodiments of the present invention.

FIG. 17 is an outward view of a user interface according to some embodiments of the present invention.

FIG. 18 is an outward view of a user interface according to some embodiments of the present invention.

FIG. 19 is an outward view of a user interface according to some embodiments of the present invention.

### DETAILED DESCRIPTION

System Architecture

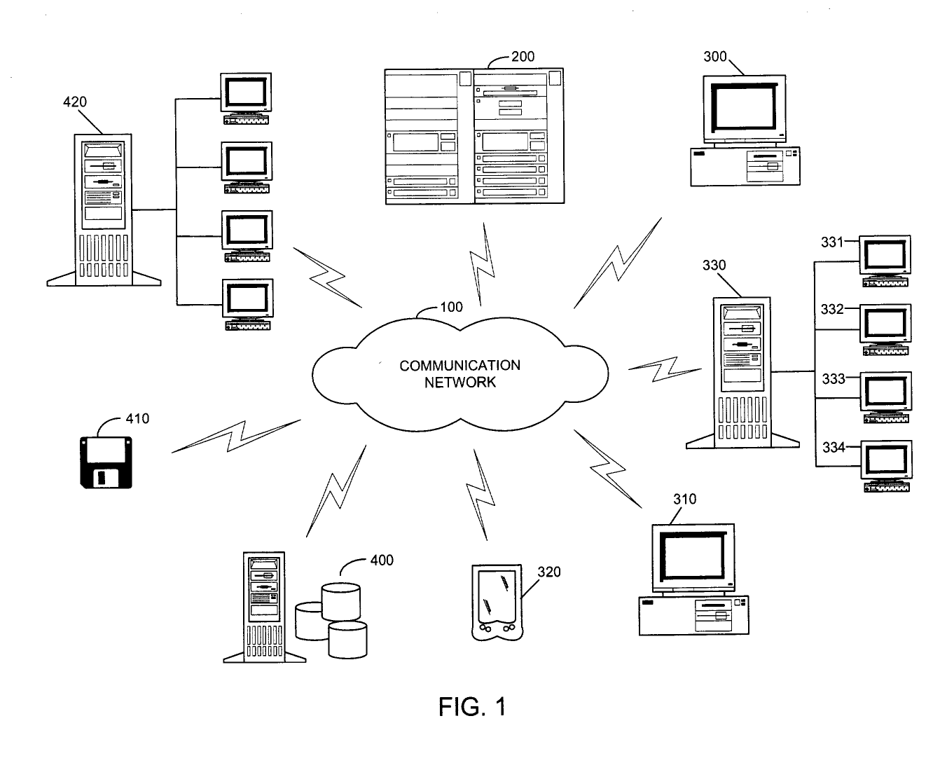

FIG. 1 illustrates an architecture of a system according to some embodiments of the present invention. As shown, communication network 100 provides communication between data warehouse 200, user devices 300, 310, 320 and 330, legacy system 400, external system media 410, and network 420.

Communication network 100 may comprise any number of different systems for transferring data, including a local area network, a wide area network, a telephone network, a cellular network, a fiber-optic network, a satellite network, an infra-red network, a radio frequency network, and any other type of network which may be used to transmit information between devices. Moreover, communication between communication network 100 and each of the depicted devices may proceed over any one or more currently or hereafter-known transmission protocol, such as Asynchronous Transfer Mode (ATM), Internet Protocol (IP), Hypertext Transfer Protocol (HTTP) and Wireless Application Protocol (WAP). In some embodiments, all data is transmitted over the World Wide Web.

Data warehouse 200 may provide data warehousing services for one or more entities. For simplicity, the present discussion will be limited to a single entity. A data warehouse is commonly used to retrieve, organize, manipulate and store disparate data generated by various business processes. Generally, a data warehouse is a repository of current and historical data pertaining to any subject, entity, or other focus. Advantageously, a data warehouse may store different types of data from different types of systems in a manner that can be efficiently searched, retrieved and analyzed. A data warehouse operated by a business may, in this regard, receive and store data from several different legacy systems operated by outside vendors, from an external server of an operational system operated by the business, and from an internal server operated by the business.

Data warehouse 200 may be utilized as described above to store current and historical data related to product underwriting. Moreover, data warehouse 200 may receive information such as repayment histories, financial exposures and demographic information associated with a plurality of organizations and/or individuals from sources 400 through 420, and may use the received information along with predefined parameters to create a user interface for use by an underwriting analyst. The user interface may be presented to and presented by user devices 300 through 330, and may include a first area for presenting a financial exposure associated with an entity, a second area for presenting a repayment rating associated with the entity, the repayment rating based at least on a repayment history of the entity, and a third area for presenting a credit score associated with the entity.

Data warehouse 200 is depicted as a mainframe server in FIG. 1, but may comprise any device or devices capable of performing process steps attributed to data warehouse 200 herein. According to one of many possible examples, data warehouse 200 is an IBM RS/6000™ server including a plurality of processors and executing the IBM AIX™ operating system and the Universal™ database management system.

User devices 300 through 330 comprise a personal computer, a personal computer, a personal digital assistant and a network server, respectively. User device 330 serves data to user terminals 331 through 334. These user devices are capable of communicating with data warehouse 200 over communication network 100, and of presenting a user interface to an analyst in operation thereof. In some embodiments, an analyst uses a user device to transmit a request for information associated with a particular entity to data warehouse 200. In response, data warehouse 200 creates and presents a user interface such as that described above to the user device, where the interface is presented to the analyst. A more detailed description of the operation of a user device in conjunction with embodiments of the present invention is set forth below.

According to the system depicted in FIG. 1, information is initially received by data warehouse from legacy system 400, external system media 410, and network 420. The information may include any data generated by an entity controlling these elements. In this regard, different entities may control one or more of data warehouse 200, legacy system 400, external system media 410, and network 420. Information may be provided from relational or non-relational databases of legacy system 400 in a specific legacy format, while external system media 410 may include any computer-readable medium, such as a diskette, a CD-ROM or a transmission from an extranet of a provider of financial information. In addition, network 420 may comprise devices, data repositories, and/or sub-networks that provide data collected and managed during execution of business-related processes of a department, division or entity. Of course, some embodiments of the present invention may operate in conjunction with other types of data received from other data sources.

Upon receiving data from sources 400 through 420, data warehouse 200 operates to transform the data into a format suitable for storing and to load the transformed data into a storage device of data warehouse 200. In order to store received data in the manner described above, the data is transformed according to business rules that apply to data usage of the particular business operating data warehouse 200. For example, received banking transactions may be transformed to comply with a format specified for data warehouse 200. Of course, it may be necessary to apply different transformation algorithms to data received from different ones of sources 400 through 420 in order to create consistently-formatted data. The transformed data may also be used to produce other data such as financial exposure indicators, repayment ratings, and credit scores that are also stored in data warehouse 200.

In other embodiments, the devices of FIG. 1 are connected differently than as shown. For example, some or all of the devices may be connected directly to one another. Of course, embodiments of the invention may include devices that are different from those shown. It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

Data Warehouse

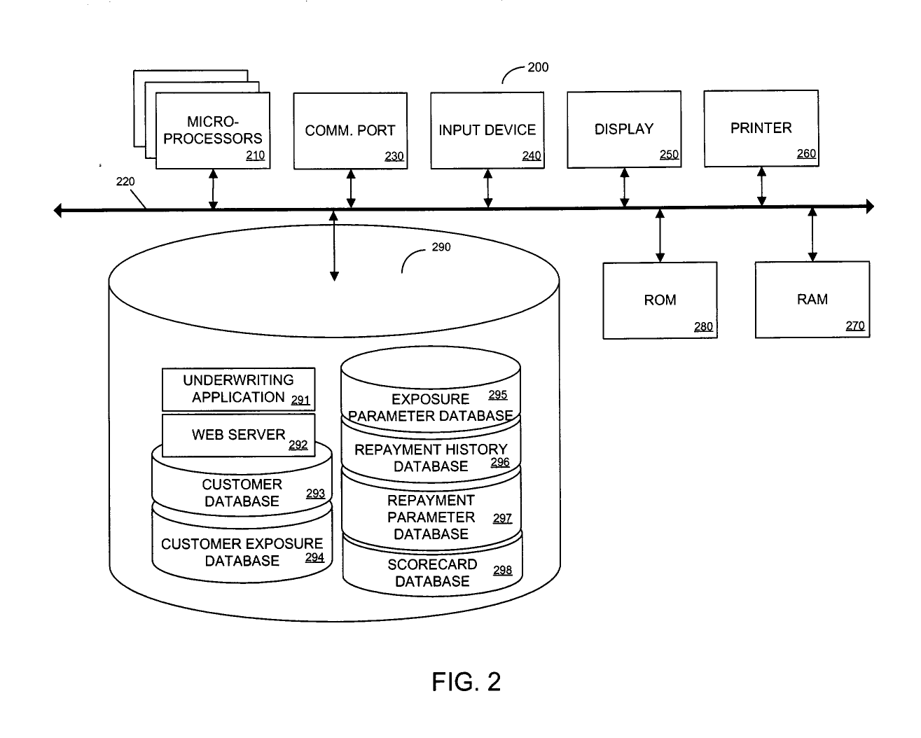

FIG. 2 is a block diagram of an internal architecture of data warehouse 200 according to some embodiments of the invention. As illustrated, data warehouse 200 includes microprocessors 210 in communication with communication bus 220. Microprocessors 210 may comprise RISC-based and other types of processors and are used to execute processor-executable process steps so as to control the elements of data warehouse 200 to provide desired functionality.

Also in communication with communication bus 220 is communication port 230. Communication port 230 is used to transmit data to and to receive data from devices external to data warehouse 200 such as devices 300 through 420. Communication port 230 is therefore preferably configured with hardware suitable to physically interface with desired external devices and/or network connections. For example, communication port 230 may comprise an Ethernet connection to a local area network through which data warehouse 200 may receive and transmit information over the Web.

Input device 240, display 250 and printer 260 are also in communication with communication bus 220. Any known input device may comprise input device 240, including a keyboard, mouse, touch pad, voice-recognition system, or any combination of these devices. Of course, information may also be input to data warehouse 200 from other devices via communication port 230. Display 250 may be an integral or separate CRT display, flat-panel display or the like used to display graphics and text in response to commands issued by microprocessors 210. Printer 260 may also present text and graphics to an operator, but in hardcopy form using inkjet, thermal, dot-matrix, laser, or other printing technologies. Elements 240 through 260 are most likely used sparingly during operation of data warehouse 200, but may be used by an operator for setup and administration.

RAM 270 is connected to communication bus 220 to provide microprocessors 210 with fast data storage and retrieval. In this regard, processor-executable process steps being executed by microprocessors 210 are typically stored temporarily in RAM 270 and executed therefrom by microprocessors 210. ROM 280, in contrast, provides storage from which data can be retrieved but to which data cannot be stored. Accordingly, ROM 280 is used to store invariant process steps and other data, such as basic input/output instructions and data used during boot-up of data warehouse 200 or to control communication port 230. It should be noted that one or both of RAM 270 and ROM 280 may communicate directly with microprocessors 210 instead of over communication bus 220.

Data storage device 290 stores, among other data, processor-executable process steps of underwriting application 291. Microprocessors 210 therefore execute the process steps of underwriting application 291 in order to control data warehouse 200 to present a user interface according to some embodiments of the present invention.

The process steps of underwriting application 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Process steps of Web server 292 are also stored in data storage device 290. These process steps may be executed by microprocessors 210 to transmit data to and to receive data from Web clients, such as Web browsers, over the Web. The data may include financial information, requests for user interfaces, commands to edit calculation parameters, and Web pages presenting user interfaces.

Customer database 293 of data storage device 290 includes demographic information associated with various customer entities. As noted above, a customer entity according to embodiments of the present invention may include any organization or individual. The demographic information associated with a customer is used in some embodiments to determine a credit score for presentation in a user interface. In some embodiments, the credit score is presented if it is determined that no repayment history associated with the customer is available.

Customer exposure database 294 stores information that can be used to determine a financial exposure associated with a customer. The information may include loan and credit details and may be received, for example, from one or more loan and/or credit servicing entities or from a system operated by an entity controlling data warehouse 200. The information may also be generated by data warehouse 200 during loan/credit administration. A financial exposure may also be determined based on parameters stored in exposure parameter database 295 of data storage device 290. As will be described below, these parameters may be edited by an authorized analyst operating one of user devices 300 through 334.

Also stored in data storage device 290 are repayment history database 296 and repayment rating database 297. Repayment history database 296 includes details of loan and/or credit repayment associated with a plurality of entities. These details may also be received from a system controlled by an operator of data warehouse 200, received from one or more loan and/or credit servicing entities, and/or generated by data warehouse 200. Repayment rating database 297 stores parameters used in conjunction with information stored in repayment history database to determine a repayment rating associated with a customer. Again, these parameters may be edited by an authorized analyst operating one of user devices 300 through 334.

Scorecard database 298 defines credit score parameters used to determine a credit score associated with a customer. The credit score parameters may also be edited by an authorized analyst, and may be used if it is determined that repayment history information associated with a customer is not available.

Also stored in data storage device 290 may also be other unshown elements that may be necessary for operation of data warehouse 200, such as an operating system, a database management system, other applications, other data files, and “device drivers” for allowing microprocessors 210 to interface with devices in communication with communication port 230. These elements are known to those skilled in the art, and are therefore not described in detail herein.

User Device

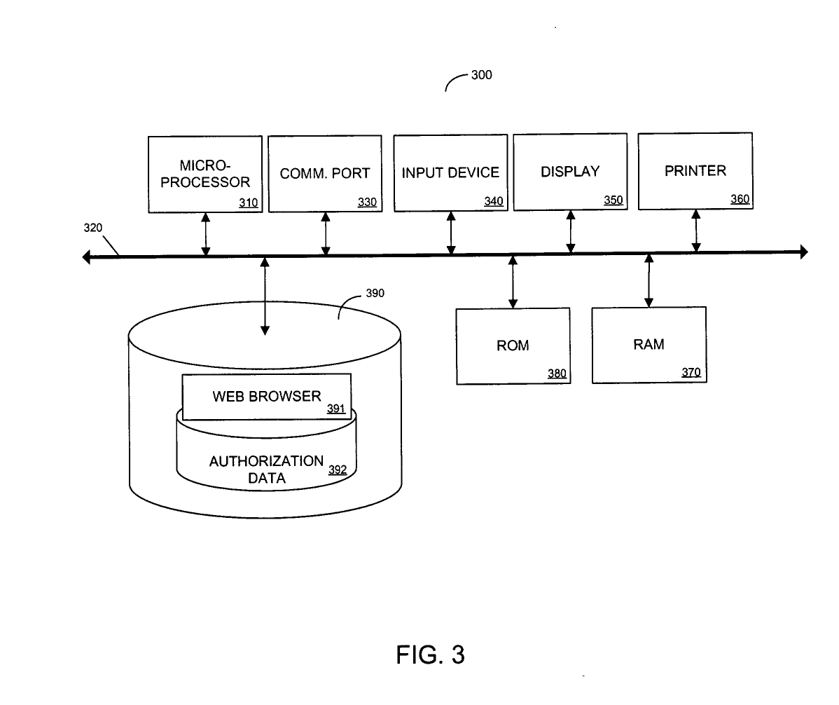

FIG. 3 illustrates several components of user device 300 according to some embodiments of the invention. It should be noted that these distinct components may comprise any of the specific examples offered with respect to identically-named components of data warehouse 200. Of course, specific functions performed by the components may differ from the functions performed by the identically-named components.

For example, communication port 330 may be used to transmit requests for information to data warehouse 200. In this regard, input device 340 may be used by an analyst to request a user interface according to some embodiments of the invention by inputting customer information into a user interface presented by display 350 and to input commands to output the subsequently-received user interface via printer 360. Input device 340, display 350 and printer 360 may also be used in conjunction with other applications provided by user device 300 which are unrelated to the present invention.

Storage device 390 of user device 300 stores processor-executable process steps of Web browser 391. The process steps may be executed by microprocessor 310 to allow communication with Web servers such as Web server 292 of data warehouse 200. Authorization data 392 includes information used to determine whether an analyst operating user device 300 is authorized to access particular user interfaces provided by data warehouse 200. Several different authorization levels may be used in conjunction with some embodiments of the invention. For example, an analyst may be allowed to receive user interfaces according to the present invention but may be prevented from editing some parameters used to determine information presented by the user interfaces, while another analyst may possess authorization for both functions. The information stored in authorization data 392 may comprise Web cookies.

Storage device 390 may store one or more of other applications, data files, device drivers and operating system files needed to provide functions other than those directly related to the present invention. Such functions may include calendaring, e-mail access, word processing, accounting, presentation development and the like.

Databases

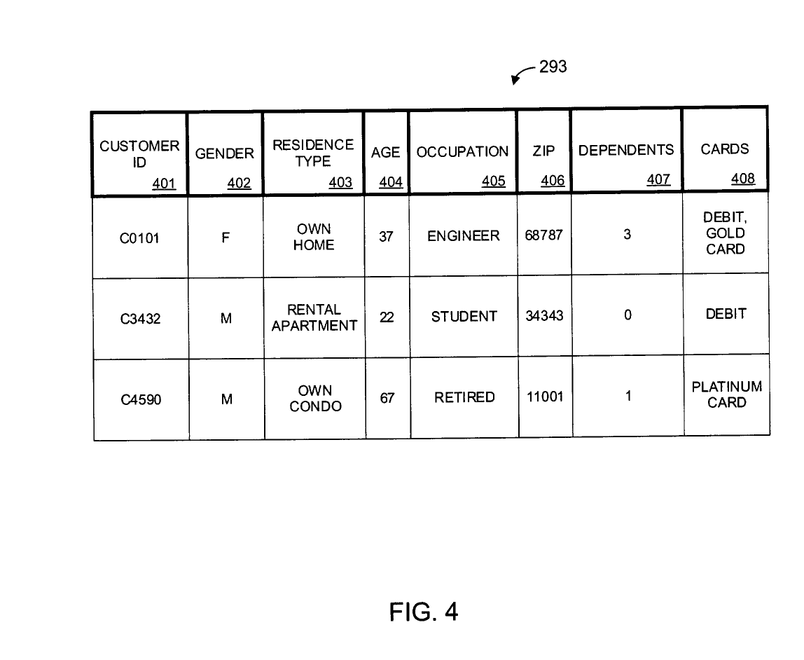

A tabular representation of a portion of customer database 293 is shown in FIG. 4. As described above, the information stored in customer database 293 may include demographic information associated with various customer entities. In one example, the information is read from a loan or credit application and entered by an operator of data warehouse 200 through input device 240. The information may also be received from another device such as sources 400 through 420 and may be generated during a process unrelated to a loan or credit application.

Customer database 293 includes several records and associated fields. The fields include customer Id field 401, gender field 402, residence type field 403, age field 404, occupation field 405, zip field 406, dependents field 407 and cards field 408. Customer Id field 401 includes an identifier associated with a customer entity. The identifier may be used to locate records associated with the entity and stored in data warehouse 200. Each of fields 402 through 407 of a particular record respectively specifies gender, residence type, age, occupation, zip and dependents of a customer associated with the record. Cards field 408 of the record specifies credit cards held by the associated customer. It should be noted that information specified in fields of customer database 293 may be received from a plurality of sources.

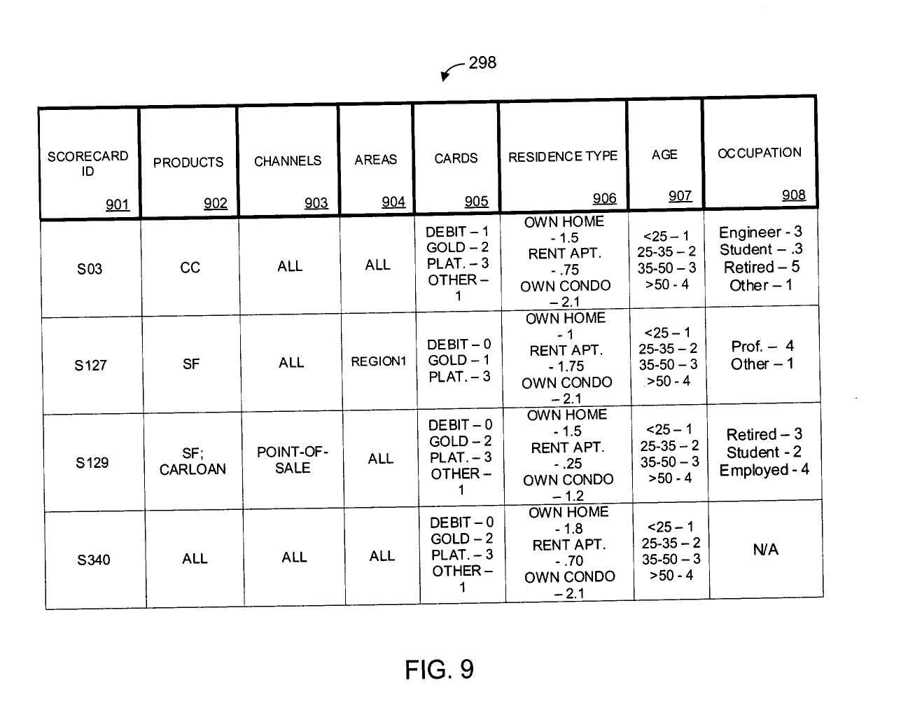

In some embodiments, the information of customer database 293 is used to determine a credit score associated with an entity. The credit score is determined using information stored in scorecard database 296, which is described below with respect to FIG. 9. The credit score is presented in some embodiments if it is determined that no repayment history associated with the customer is available.

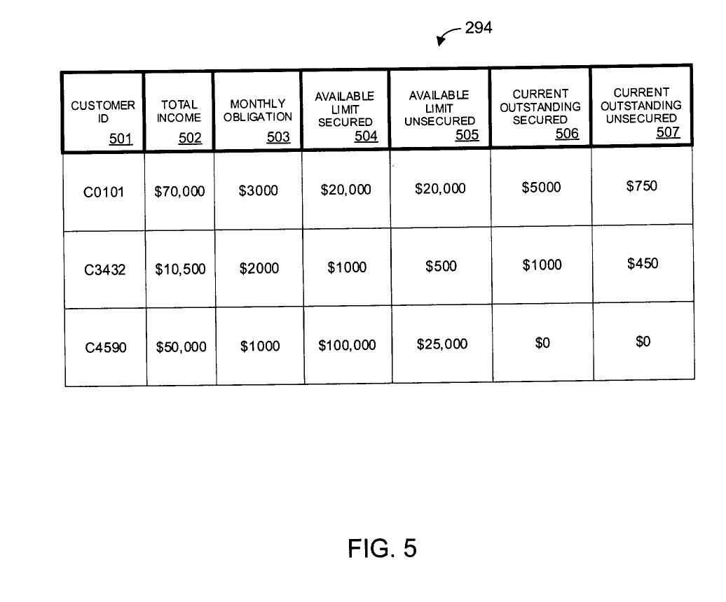

FIG. 5 illustrates a tabular representation of a portion of customer exposure database 294. The illustrated portion includes a plurality of records, each including a number of fields. The fields include customer Id field 501, total income field 502, monthly obligations field 503, available limit (secured) field 504, available limit (unsecured) field 505, current outstanding (secured) field 506, and current outstanding (unsecured) field 507. Data populating fields 502 through 507 for a particular record includes information associated with a customer identified by customer Id field 501 of the record. The information of customer exposure database is used in some embodiments to present a financial exposure to an analyst. Such an embodiment will be described below.

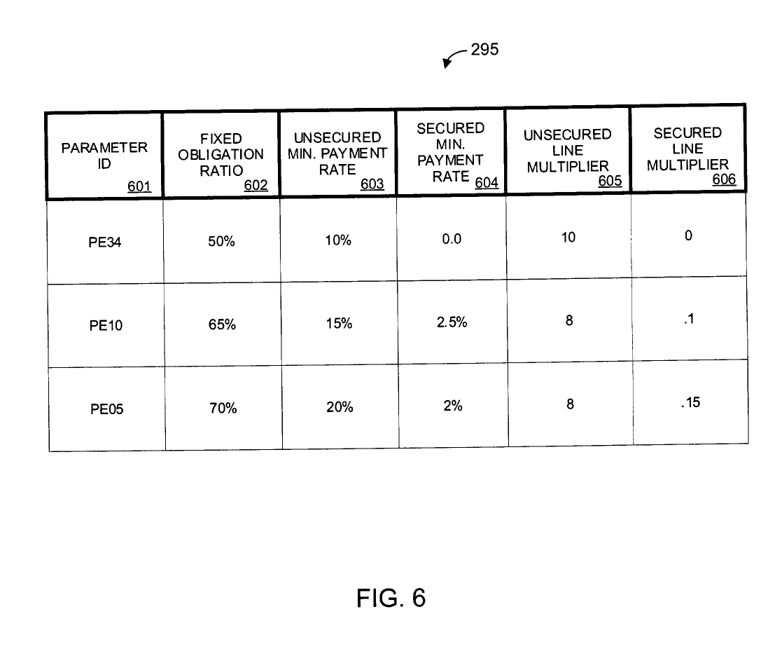

A tabular representation of a portion of exposure parameter database 295 is illustrated in FIG. 6. Exposure parameter database 295 stores sets of parameters that are used in some embodiments to determine a financial exposure associated with an entity. In one example, a formula to determine a financial exposure associated with an entity may require values for certain parameters and for certain information associated the entity in customer exposure database 294. A set of parameters is selected from exposure parameter database 295, appropriate information is selected from customer exposure database 294, and the financial exposure is determined based on the formula and on the selected parameters and information.

The fields of exposure parameter database 295 as shown in FIG. 6 include parameter ID field 601, fixed obligation ratio field 602, unsecured minimum payment rate field 603, secured minimum payment rate field 604, unsecured line multiplier field 605 and secured line multiplier field 606. Parameter ID field 601 of a particular record includes an identifier of a set of parameter values specified in the particular record. The identifier may be used to select a set of parameter values used to calculate a financial exposure according to some embodiments of the invention. Such selection may be based on any number of factors that will be set forth below. The contents of fields 602 through 606 are self-explanatory based on their respective field names, and may be specified and/or edited by an appropriately authorized operator of data warehouse 200 or analyst using user device 400.

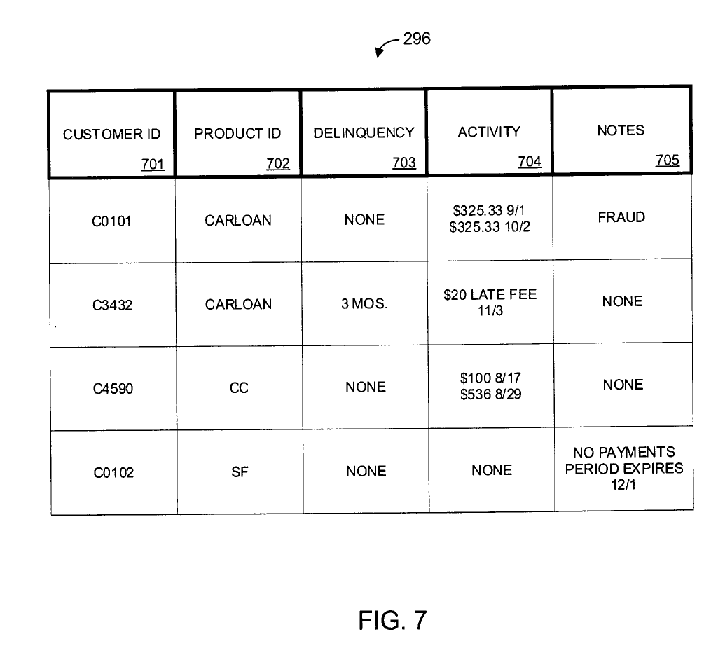

FIG. 7 illustrates a tabular representation of a portion of repayment history database 296. Each record of repayment history database 296 stores repayment information associated with a customer entity. Accordingly, customer Id field 701 of a record includes an identifier identifying the customer entity associated with the record. As shown, a single customer identifier may be associated with more than one record of repayment history database 296.

The remaining illustrated fields include product Id field 702, delinquency field 703, activity field 703, and notes field 704. Product Id field 702 specifies a financial product for which the subject record specifies repayment information. Delinquency field 703 and activity field 704 specify, respectively, any delinquencies and repayment activities of the associated customer that pertain to the associated product. Notes field 705 allows notes or flags to be associated with a customer's repayment history. The fields of repayment history database 296 may be populated by information received from a loan or credit servicing agency, from a collections agency, and/or from other internal or external entities.

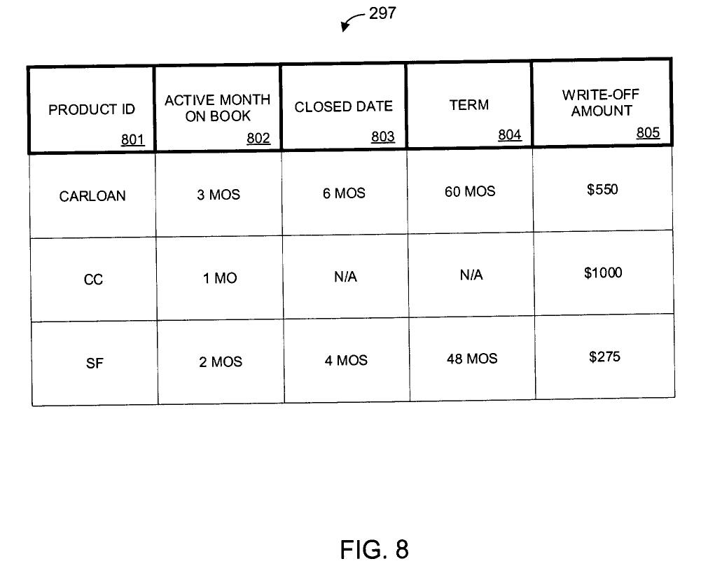

A tabular representation of a portion of repayment parameter database 297 is shown in FIG. 8. The records of database 297 include product Id field 801, active month on book field 802, product closed date 803, term 804, and write-off amount 805. Product Id field 801 identifies a product that is the subject of a record, while fields 802 through 805 provide values for parameters used to determine a repayment rating associated with a subject product. The values may be edited by an appropriately-authorized operator and/or analyst as described below.

Repayment parameter database 297 stores sets of parameters that are used in some embodiments to determine a repayment rating associated with an entity. In some embodiments, a formula used to determine a repayment rating to associate with an entity includes variables representing certain parameters and certain repayment history information. Accordingly, a set of appropriate parameters is selected from repayment parameter database 297, appropriate repayment history information is selected from repayment history database 296, and the repayment rating is determined based on the formula and on the selected parameters and information. In some embodiments, a repayment rating is not determined if an appropriate repayment history is not available.

Scorecard database 298 specifies parameter values used to determine a credit score according to some embodiments of the invention. FIG. 9 illustrates a tabular representation of a portion of scorecard database 298. Each record is identified by scorecard Id field 901, and any products, channels or areas to which a particular scorecard is to apply are specified in products field 902, channels field 903 and areas field 904, respectively. Fields 905 through 908 specify weightings given to values specified in identically-named fields of customer database 293. The weightings are used to determine a credit score associated with a particular customer.

It should be noted that the tabular illustrations and accompanying descriptions of databases 293 through 298 merely represent relationships between stored information. A number of other arrangements may be employed besides those suggested, including arrangements in which some or all of the specified data is located remote from data warehouse 200. It is further contemplated that each of databases 293 through 298 may include many more records than those shown and that each record may include associated fields other than those illustrated. In particular, databases 295, 297 and 298 may specify any parameters that might be required to determine a financial exposure, a repayment rating, and a credit score according to particular embodiments of the invention.

Process Flow

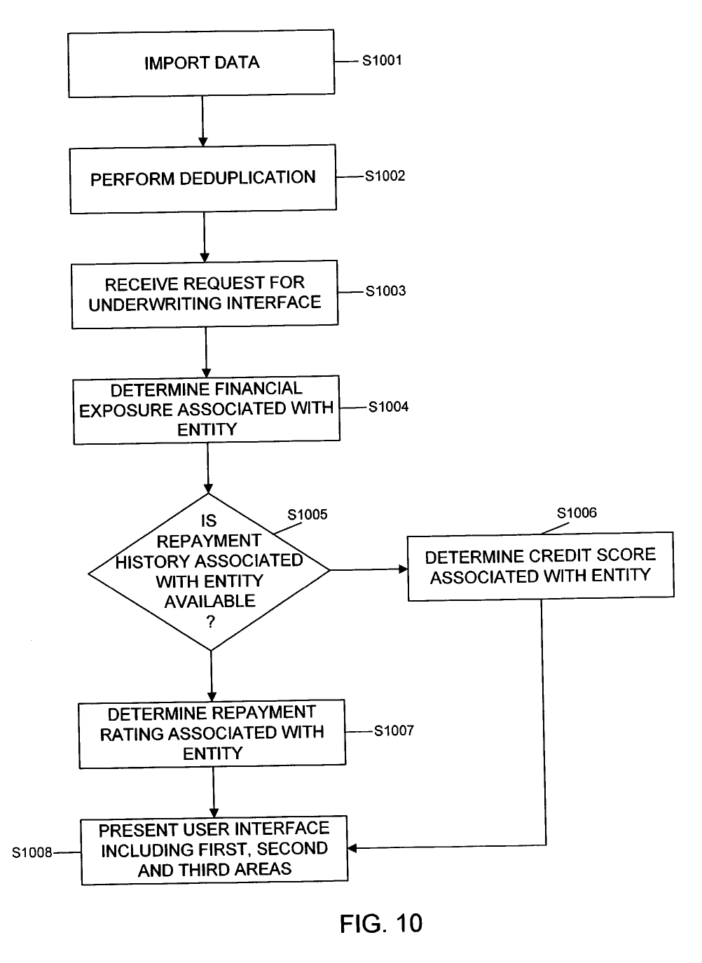

FIG. 10 comprises a flow diagram of process steps 1000 according to some embodiments of the present invention. Process steps 1000 are described below as if embodied in underwriting application 291 and executed by microprocessors 210 of data warehouse 200. However, process steps 1000 may be embodied in one or more software or hardware elements and executed, in whole or in part, by any device or by any number of devices in combination, including user device 300. Moreover, some or all of process steps 1000 may be performed manually.

Briefly, process steps 1000 may be executed to present a user interface comprising a first area for presenting a financial exposure associated with an entity, a second area for presenting a repayment rating associated with the entity, the repayment rating based at least on a repayment history of the entity, and a third area for presenting a credit score associated with the entity.

Data is imported from sources such as sources 400 through 420 in step S1001. The sources may be based on diverse origination platforms such as LSI Magic, LSINT and AS/400. More particularly, data entry personnel enter application information on a respective origination platform and the data is imported by data warehouse 200. The data may be imported in real-time or according to any schedule. In some embodiments, user interfaces are presented to authorized analysts to enable editing of an import schedule or manual importing. Moreover, data may be imported according to step S1001 without triggering execution of remaining process steps S1002 through S1007.

According to some embodiments of step S1001, a data source stores data in a temporary file. Process steps of an import application, possibly embodied in underwriting application 291, import the data from the temporary file to data warehouse 200. The data is examined, date-stamped and stored into appropriate databases and fields of data warehouse 200.

Data stored in data warehouse 200 is subjected to deduplication in step S1002. Because data warehouses receive large amounts of data from different sources, the received data is often duplicative of other stored or received data. Problems may occur if the duplicative data is not recognized as such. Accordingly, deduplication systems have been developed to address the problem of duplicate records.

As described with respect to step S1001, deduplication may be performed according to any defined schedule or in response to any defined event including in response to a command received from an authorized analyst or operator of data warehouse 200. That is, steps S1001 and/or S1002 may be performed at any time in accordance with some embodiments of the invention and do not necessarily immediately precede steps S1003 through S1007.

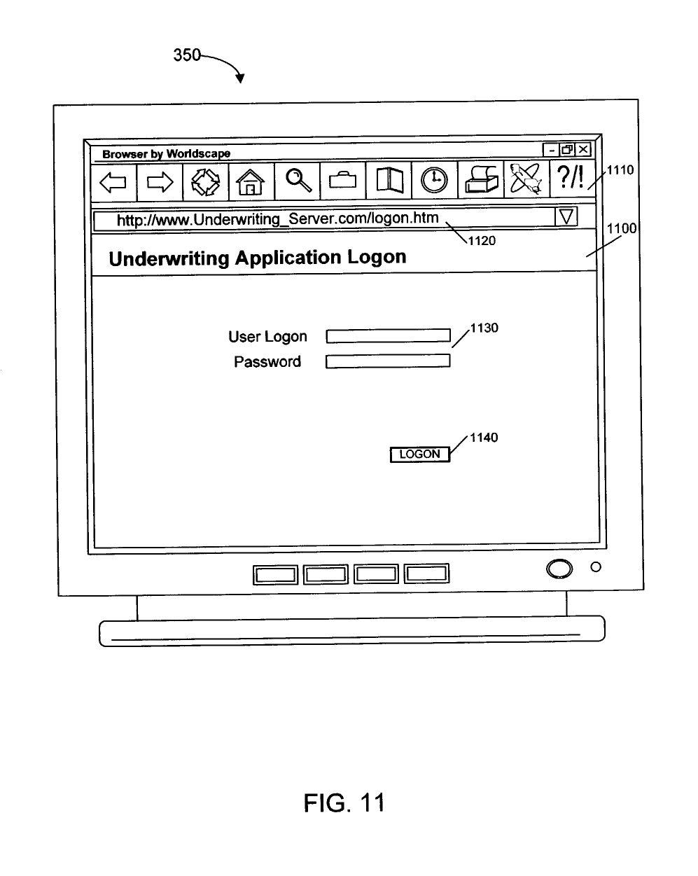

A request for an underwriting interface is received in step S1003. In the present example, the request is received from user device 300 in response to commands and data input by an analyst to Web browser 391. FIGS. 11 through 13 illustrate interfaces used to input such commands and data according to some embodiments of the present invention.

Specifically, FIG. 11 is an outward view of logon page 1100 as received by user device 300 and displayed by display 350 according to some embodiments of the invention. Prior to display of page 1100, Web browser 391 is executed to display browser window 1110. A Uniform Resource Locator identifying Web server 292 is input into address bar 1120 using input device 340 and, in response, Web browser 391 transmits a request for a home page to Web server 292.

Logon page 1100 is transmitted to user device 300 in response to the received request. Logon page 1100 includes input area 1130 into which an analyst enters authorization data to access particular user interfaces provided by data warehouse 200. In some embodiments, authorization data 392 is used to automatically populate input area 1130 upon receipt of logon page 1100. Logon button 1140 is selected after authorization data is input into input area 1130, and the authorization data is transmitted to data warehouse 200 as a result.

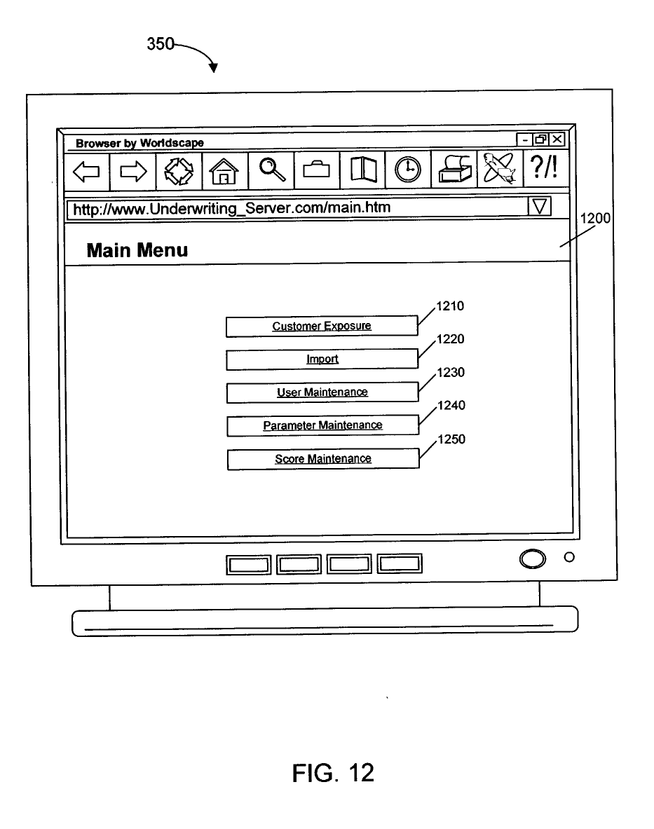

Data warehouse 200 analyzes the authorization data to determine if the analyst possesses appropriate permission and, if so, transmits main menu page 1200 of FIG. 12 to user device 300. As shown, main menu page 1200 includes customer exposure button 1210, import button 1220, user maintenance button 1230, parameter maintenance button 1240 and score maintenance button 1250. In some embodiments, main menu page 1200 presents only buttons corresponding to functions that the analyst is authorized to access. In the present example, it is assumed that the analyst selects customer exposure button 1210.

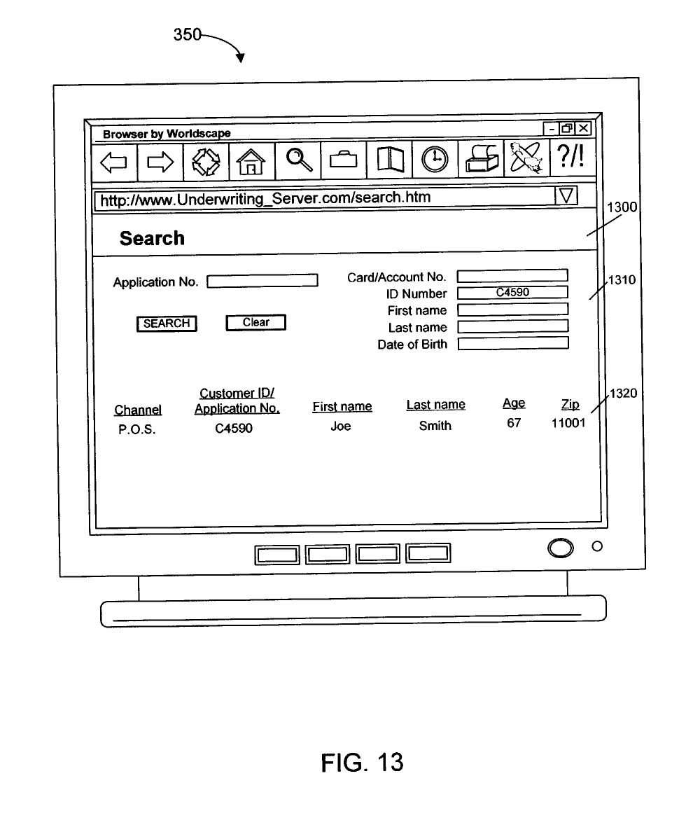

Accordingly, search page 1300 is transmitted to user device 300 and presented by display 350 as shown in FIG. 13. Search page 1300 includes search interface 1310, which allows the analyst to search for an application and/or a customer based on criteria including application number, account number, customer Id, first name, last name, and/or date of birth. In some embodiments, certain users may be allowed to search based only on application number, while users having greater authorization may be able to use all the search fields listed above.

Search results are displayed in search result area 1320. Displayed in association with each search result are a channel from which the search result data was obtained, a customer Id or application number, a first name, a last name, an age, and a zip code. In some embodiments, selection of a displayed search result causes data warehouse to receive a request for an underwriting interface in step S1003.

Accordingly, a financial exposure associated with an entity corresponding to the selected search result is determined in step S1004. The financial exposure may be determined using any currently or hereafter-known system for determining financial exposure. In some examples, determination of financial exposure simply comprises collecting data related to a financial exposure of the entity, such as the data stored in customer exposure database 294. Additionally, determination of financial exposure includes using some or all of such data to calculate one or more values indicative of a financial exposure. In the present example, step S1004 includes calculation of a “% open to buy” value that reflects a percentage of credit extended to an entity that is currently unused. Therefore, values of fields 504 through 507 that are associated with the selected entity are used to calculate the “% open to buy” value. Of course, other financial exposure values may be calculated using other types of data from other sources to determine a financial exposure according to embodiments of step S1004.

Next, in step S1005, it is determined whether a repayment history associated with the entity is available. According to the present example, records of repayment history database 296 are analyzed to locate a record that is associated with a customer Id representing the selected entity. If such a record is located, flow continues to step S1006. In some embodiments, data warehouse 200 determines whether it is able to access, from local or remote databases or devices, alone or in combination, at least an amount of repayment history information needed to determine a repayment rating. Of course, this amount depends on the values required by the particular repayment rating formula that is to be used in conjunction with the present invention.

In this regard, the repayment history is used to determine a repayment rating in step S1006. The repayment rating may be calculated using any current or future system. According to the present example, the repayment rating calculation results in a customer classification of either Good, Bad or Indeterminate. Next, in step S1007, a user interface is presented to user device 300 by data warehouse 200 and is thereafter presented to an analyst through display 350.

On the other hand, in a case that it is determined in step S1005 that an appropriate repayment history is not available, a credit score associated with the entity is determined in step S1008. In some embodiments, the credit score is determined based on demographic information such as that shown in customer database 293 of FIG. 4. The credit score, in some embodiments, is not based on a repayment history of the entity. Accordingly, a repayment rating is determined for those entities for which a repayment history is available, and a credit score is determined for those “new” entities for which no such history is available. Flow also proceeds to step S1007 after step S1008.

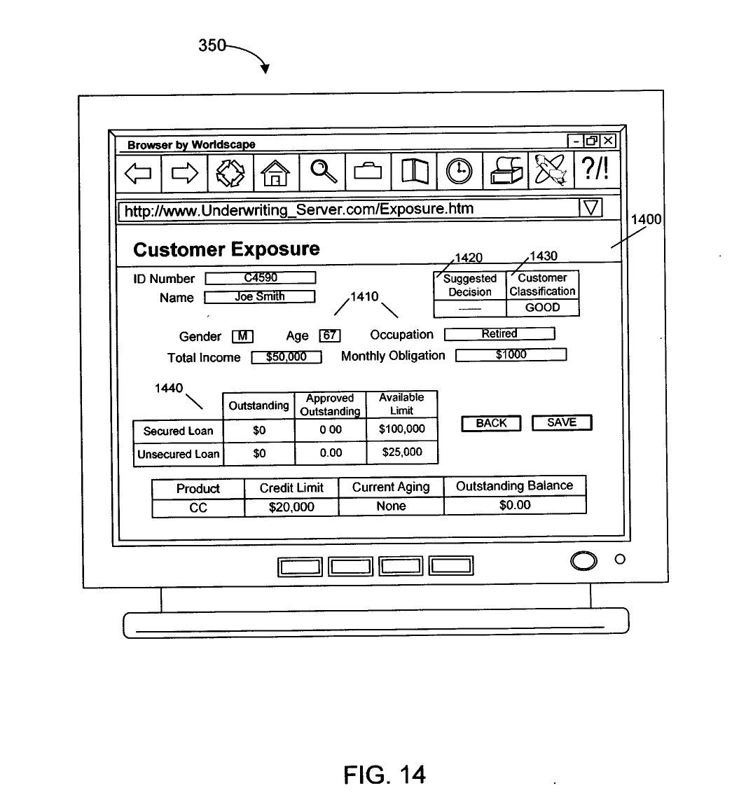

FIG. 14 shows a user interface presented according to some embodiments of step S1007. As shown, user interface 1400 includes customer information area 1410 presenting a customer Id, name, and other demographic information. In the present example, the data populating information area 1410 is taken from an associated record of customer database 293.

User interface 1400 also includes credit score area 1420 for presenting a credit score associated with the customer, repayment rating area 1430 for presenting a repayment rating associated with the customer, and financial exposure area 1440 for presenting a financial exposure associated with the customer. A credit score is presented in credit score area 1420 if the credit score has been determined for the customer in step S1008. As described above, a credit score will therefore be presented, in some embodiments, only in a case that a repayment history needed to determine a repayment rating for the customer is not available.

Repayment rating area 1430 presents a repayment rating associated with the customer if the rating was determined in step S1006. In the example of FIG. 14, a repayment rating was determined and is presented because appropriate rating history information associated with the customer was available in repayment history database 296. As shown, the determined repayment rating is “Good”.

Financial exposure area 1440 includes information indicating a financial exposure associated with the customer entity. The information may include the financial exposure determined in step S1004, which may include raw data from customer exposure database 294 and/or values calculated therefrom using appropriate parameters of exposure parameter database 295. For example, financial exposure area 1440 may present an amount of unused credit associated with an entity. It should be noted that user interfaces according to embodiments of the present invention may include elements different from those described herein, and the elements thereof may be arranged and/or presented differently than described herein.

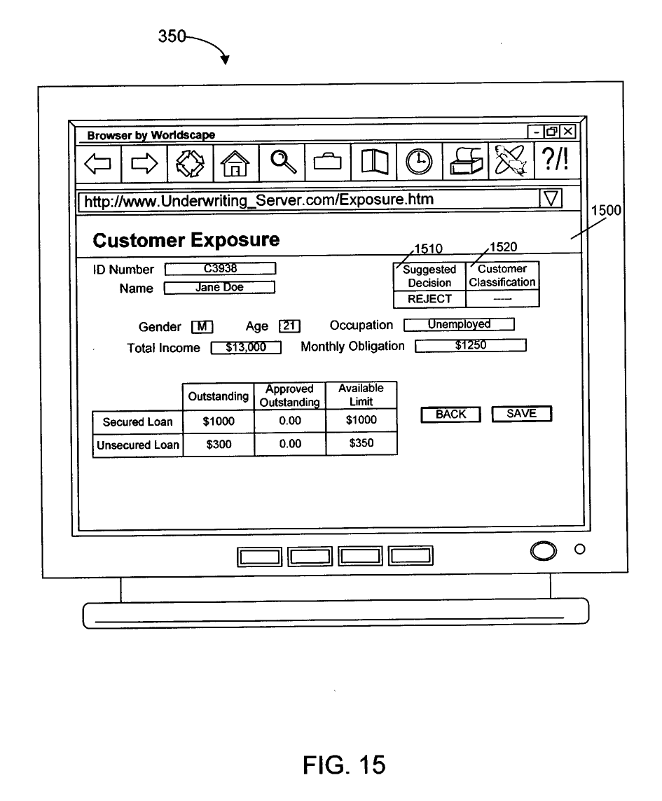

FIG. 15 shows user interface 1500, which reflects a customer entity for which an appropriate repayment history is not available. As a result, no repayment rating was determined for the customer, a credit score was determined, area 1510 presents the determined credit score, and area 1520 does not present a repayment rating.

Accordingly, some embodiments, such as that reflected in user interface 1400, provide an analyst with a tool to perform efficient and adequate analysis of an entity for underwriting purposes, regardless of whether or not an appropriate repayment history associated with the entity is available. It should be noted that steps to present such an interface may differ widely from process steps 1000. For example, a financial exposure, credit score and/or repayment rating associated with an entity may be determined at any time prior to presentation of a user interface in step S1007. Moreover, in some embodiments, a user interface according to the present invention may be presented by an underwriting client application executed by user device 300 that receives raw data and/or pre-calculated values from data warehouse 200.

According to some embodiments, further user interfaces are provided to allow an analyst to define and/or edit parameters used to determine the financial exposure, repayment rating and/or credit score. User interfaces may also be provided to create a plurality of sets of parameters corresponding to one or more of the financial exposure, repayment rating and credit score, and to define situations in which a particular set of parameters is used.

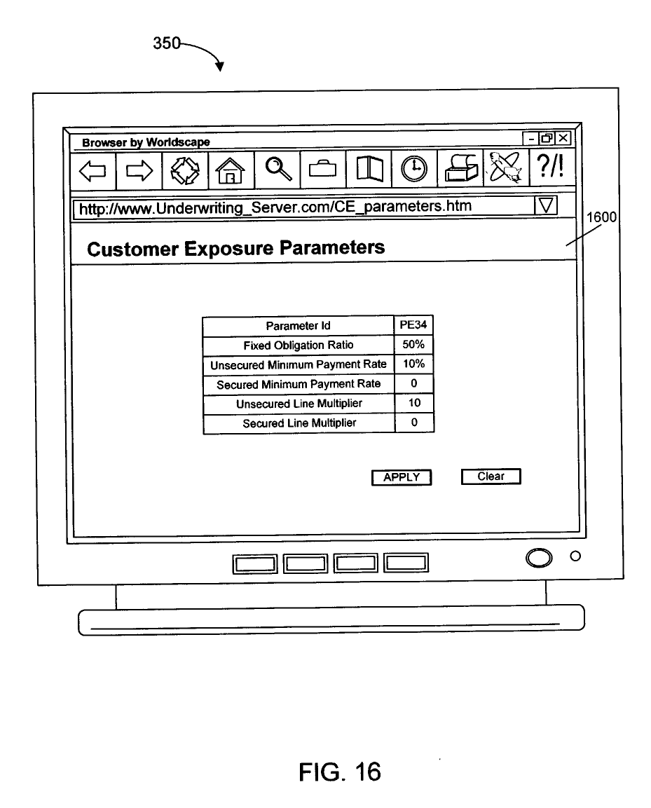

User interface 1600 of FIG. 16, for example, may be received by user device 300 in response to a selection of parameter maintenance button 1240 of user interface 1200. Of course, an analyst may be required to navigate through several user interfaces after selection of button 1240 in order to view a user interface that is associated with particular parameters to be edited. The parameters shown in user interface 1600 are those for which values are stored in exposure parameter database 295. User interface 1600 allows an analyst to define a set of parameters set can be used to determine a financial exposure associated with a customer. As will be described below, an analyst may also define conditions under which a particular set of parameters is used to determine a financial exposure.

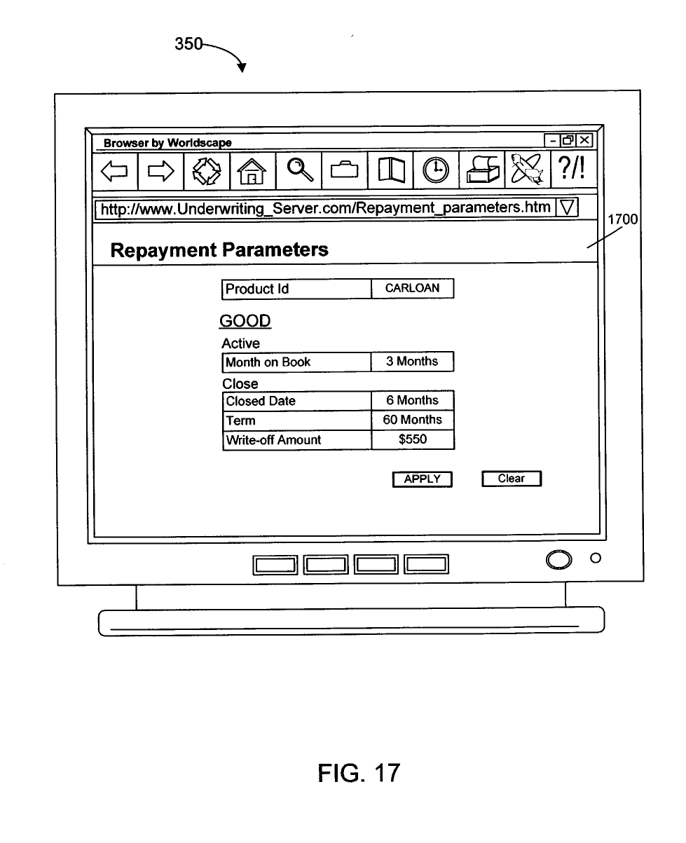

User interface 1700 of FIG. 17 may also be presented in response to selection of parameter maintenance button 1240 and subsequent navigation. User interface 1700 provides an interface to define and to edit parameters used to determine a repayment rating according to some embodiments of the present invention. The parameters shown in FIG. 17 correspond to the fields of repayment parameter database 297. Accordingly, user interface 1700 may be used to store and edit parameter values of database 297.

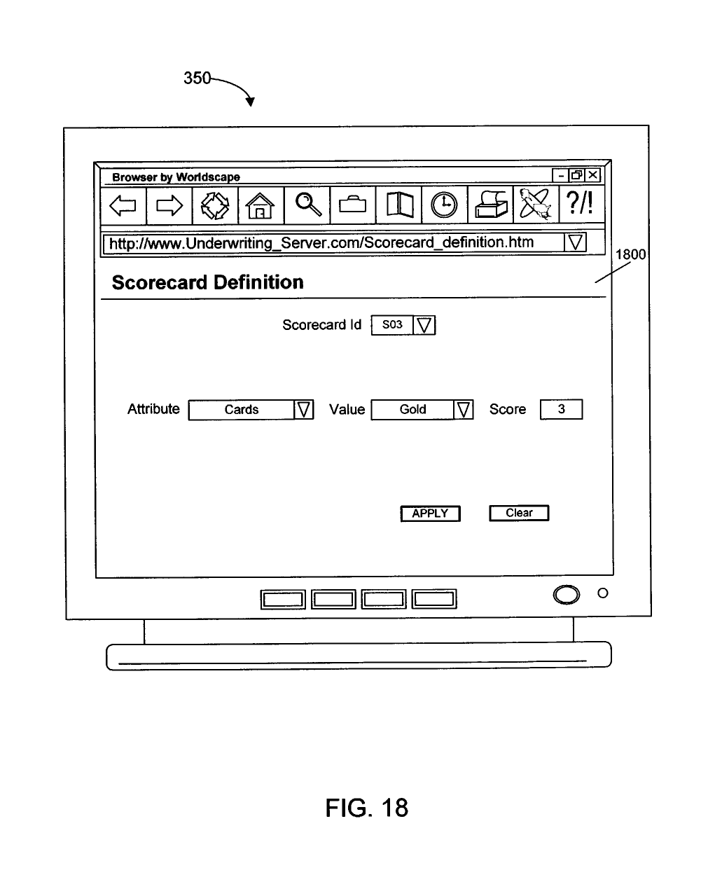

FIG. 18 illustrates user interface 1800, which is presented by display 350 after selection of score maintenance button 1250 of user interface 1200. User interface 1800 allows an analyst to define attribute values and corresponding scores to associate with a particular scorecard in scorecard database 298. In other words, user interface 1800 allows an analyst to define and edit formulas used to compute credit scores.

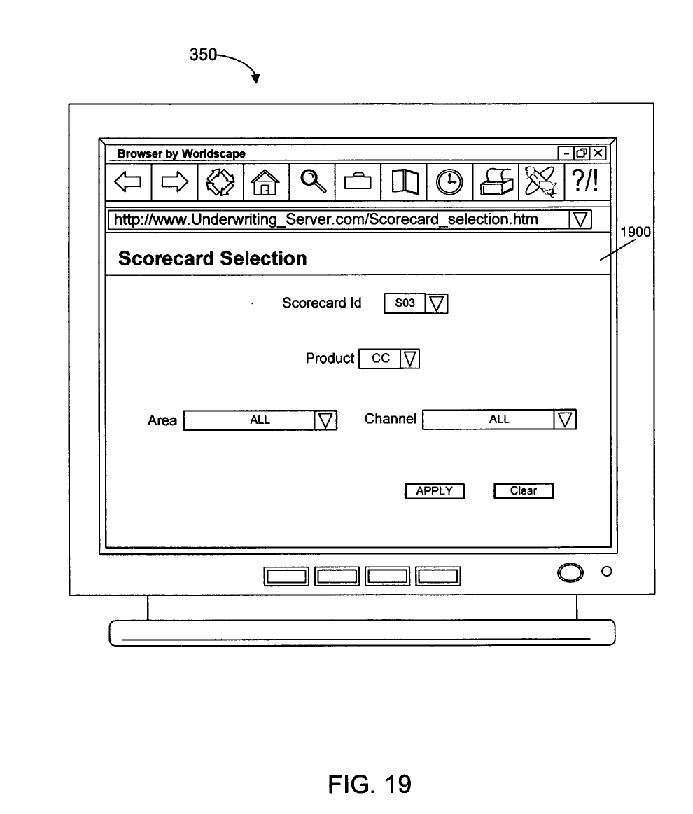

As shown in database 298, more than one set of parameters is available for determination of a credit score. Accordingly, each record of database 298 may be associated with one or more products, geographic areas or customer channels via fields 902 through 904. User interface 1900 of FIG. 19 allows an analyst to specify the products, areas, or channels to associate with a particular set of parameters. As a result, parameters used to determine a credit score may differ depending on the subject product, the geographic area of the subject customer, and/or the channel used lo to obtain the product application.

To complete the description of user interface 1200, import button 1220 may be used to perform tasks related to importing data from one or more sources and/or relating to one or more products, such as scheduling imports, initiating a manual import, performing deduplication, or purging data. Moreover, user maintenance button 1230 provides access to user interfaces for adding and deleting users, changing passwords and defining user privileges. In this regard, it should be noted that access to user interfaces 1600 through 1900 as well as to the other interfaces described above is dependent on an analyst's privileges. Authorization to use any combination of interfaces may be selectively granted to any analyst.

Although the present invention has been described above with respect to some embodiments thereof, it should be noted that, the above-described embodiments may be altered to create completely or partially different embodiments of the invention without departing from the spirit and scope of the appended claims.

What is claimed is:

1. A user interface comprising:
a first area for presenting a financial exposure associated with an entity;
a second area for presenting a repayment rating associated with the entity, the repayment rating based at least on a repayment history of the entity; and
a third area for presenting a credit score associated with the entity.

2. A user interface according to claim 1, wherein the first area indicates an amount of unused credit associated with the entity.

3. A user interface according to claim 1, wherein the repayment rating is based at least on repayment rating parameters, and wherein the user interface further comprises areas for receiving input that are usable to navigate to a second user interface for editing the repayment rating parameters.

4. A user interface according to claim 1, wherein the credit score is based at least on credit score parameters, and wherein the user interface further comprises areas for receiving input that are usable to navigate to a second user interface for editing the credit score parameters.

5. A user interface according to claim 1, wherein the financial exposure is based at least on exposure parameters, and wherein the user interface further comprises areas for receiving input that are usable to navigate to a second user interface for editing the exposure parameters.

6. A user interface according to claim 1, wherein a first set of parameters is used to determine a credit score corresponding to a first product, and wherein a second set of parameters is used to determine a credit score corresponding to a second product.

7. A user interface according to claim 1, wherein a first set of parameters is used to determine a credit score corresponding to a first geographic area, and wherein a second set of parameters is used to determine a credit score corresponding to a second geographic area.

8. A user interface according to claim 1, wherein a first set of parameters is used to determine a credit score corresponding to a first channel, and wherein a second set of parameters is used to determine a credit score corresponding to a second channel.

9. A user interface according to claim 1, wherein a first set of parameters is used to determine a repayment rating corresponding to a first product, and wherein a second set of parameters is used to determine a repayment rating corresponding to a second product.

10. A user interface according to claim 1, wherein the user interface further comprises a fourth area for editing parameters used to determine the repayment rating.

11. A user interface according to claim 1, wherein the user interface further comprises a fourth area for editing parameters used to determine the credit score.

12. A user interface according to claim 1, wherein the user interface further comprises a fourth area for editing parameters used to determine the financial exposure.

13. A user interface according to claim 1, wherein the repayment rating is presented in the second area if an appropriate repayment history is available, and wherein the credit score is presented in the third area if an appropriate repayment history is not available.

14. A user interface according to claim 1, wherein the credit score is not based on the repayment history of the entity.

15. A user interface according to claim 1, wherein the first area, the second area and the third area are presented simultaneously.

16. A computer-readable medium storing processor-executable process steps to present a user interface, the steps comprising:
a step to present a first area of the user interface, the first area presenting a financial exposure associated with an entity;
a step to present a second area of the user interface, the second area presenting a repayment rating associated with the entity, the repayment rating based at least on a repayment history of the entity; and
a step to present a third area of the user interface, the third area presenting a credit score associated with the entity.

17. A medium according to claim 16, wherein the credit score is not based on the repayment history of the entity.

18. A medium according to claim 16, the process steps further comprising:
determining if an appropriate repayment history is available;
presenting the repayment rating in the second area if it is determined that an appropriate repayment history is available; and
presenting the credit score in the third area if it is determined that an appropriate repayment history is not available.

19. A medium according to claim 16, wherein the first area, the second area and the third area are presented simultaneously.

20. A medium according to claim 16, wherein the repayment rating is based at least on repayment rating parameters, and wherein the user interface further comprises areas for receiving input that are usable to navigate to a second user interface for editing the repayment rating parameters.

21. A medium according to claim 16, wherein the credit score is based at least on credit score parameters, and wherein the user interface further comprises areas for receiving input that are usable to navigate to a second user interface for editing the credit score parameters.

22. A medium according to claim 16, wherein the financial exposure is based at least on exposure parameters, and wherein the user interface further comprises areas for receiving input that are usable to navigate to a second user interface for editing the exposure parameters.

23. An apparatus comprising:
a processor; and
a storage device in communication with the processor and storing instructions adapted to be executed by the processor to:
present a first area of the user interface, the first area presenting a financial exposure associated with an entity;
present a second area of the user interface, the second area presenting a repayment rating associated with the entity, the repayment rating based at least on a repayment history of the entity; and
present a third area of the user interface, the third area presenting a credit score associated with the entity.

24. An apparatus according to claim 23, wherein the credit score is not based on the repayment history of the entity.

25. An apparatus according to claim 23, the stored instructions further adapted to be executed by the processor to:
determine if an appropriate repayment history is available;
present the repayment rating in the second area if it is determined that an appropriate repayment history is available; and
present the credit score in the third area if it is determined that an appropriate repayment history is not available.

26. An apparatus according to claim 23, wherein the first area, the second area and the third area are presented simultaneously.

27. An apparatus according to claim 23, wherein the repayment rating is based at least on repayment rating parameters, and wherein the user interface further comprises areas for receiving input that are usable to navigate to a second user interface for editing the repayment rating parameters.

28. An apparatus according to claim 23, wherein the credit score is based at least on credit score parameters, and wherein the user interface further comprises areas for receiving input that are usable to navigate to a second user interface for editing the credit score parameters.

29. An apparatus according to claim 23, wherein the financial exposure is based at least on exposure parameters, and wherein the user interface further comprises areas for receiving input that are usable to navigate to a second user interface for editing the exposure parameters.

30. A system comprising:
a data repository storing information associated with a plurality of entities; and
a device for receiving a user interface created based on the stored information, the user interface comprising:
a first area for presenting a financial exposure associated with an entity based on the stored information;
a second area for presenting a repayment rating associated with the entity, the repayment rating based at least on a repayment history of the entity stored in the data repository; and
a third area for presenting a credit score associated with the entity, the credit score based at least on demographic information stored in the data repository.

31. A user interface for evaluating an underwriting decision, comprising:
a first area for presenting a financial exposure associated with an entity, the financial exposure including at least an indication of an outstanding loan balance of the entity;
a second area for presenting a repayment rating associated with the entity; and
a third area for presenting a credit score associated with the entity, the credit score based at least on demographic information associated with the entity,
wherein the repayment rating is presented in the second area if an appropriate repayment history associated with the entity is available, and wherein the credit score is presented in the third area if the appropriate repayment history is not available.
